(19) United States
(12) Patent Application Publication
(10) Pub. No.: US 2024/0405356 A1
(43) Pub. Date: Dec. 5, 2024

(54) BATTERY STORAGE SYSTEM WITH AT LEAST TWO BATTERY MODULES

(71) Applicant: VARTA Microbattery GmbH, Ellwangen Jagst (DE)

(72) Inventors: Simon Burow, Oberkochen (DE); Dieter Kloos, Fichtenau (DE); Roman Stübler, Lauchheim (DE)

(73) Assignee: VARTA Microbattery GmbH, Ellwangen Jagst (DE)

(21) Appl. No.: 18/694,782

(22) PCT Filed: Sep. 15, 2022
(86) PCT No.: PCT/EP2022/075704

§ 371 Date: Mar. 22, 2024

(30) Foreign Application Priority Data
Sep. 28, 2021 (EP) 21199309.2

(51) Int. Cl. H01M 50/367; H01M 10/613; H01M 10/653; H01M 10/655; H01M 10/6563; H01M 50/209; H01M 50/264; H01M 50/30; H01M 50/342; H01M 50/514

(52) U.S. Cl. CPC H01M 50/367; H01M 10/613; H01M 10/653; H01M 10/655; H01M 10/6563; H01M 50/264; H01M 50/3425; H01M 50/394; H01M 50/514; H01M 50/209

(57) ABSTRACT

A battery storage system that has at least two battery modules, each of which has a plurality of electrochemical energy storage cells. Each battery module has at least one external contacting device for connection to another battery module of the battery storage system. The contacting devices comprise at least one connection for power and/or data signals. Adjacent battery modules within the battery storage system are electrically connected to one another via the contacting devices. The battery storage system is characterized in that the contacting devices are each surrounded by a circumferential mechanical guide and in that at least one gas passage opening is provided in the area of the contacting devices within the circumferential mechanical guide, via which a gas exchange can take place between adjacent battery modules.

### TECHNICAL FIELD

This disclosure relates to a battery storage system with at least two battery modules, each of which has a plurality of electrochemical energy storage cells] and furthermore, relates to a battery module that can be used in particular in such a battery storage system or as a stand-alone battery module.

### BACKGROUND

A battery is a storage device for electrical energy that is made up of a number of electrochemical energy storage cells. Larger batteries are usually made up of battery modules, which can comprise either individual energy storage cells or several interconnected energy storage cells. The number of energy storage cells contained in a battery module depends on the required currents and voltages. Applications in the field of electromobility or for large stationary energy storage systems generally require very high currents and high voltages and a correspondingly large number of energy storage cells.

Each electrochemical energy storage cell comprises at least one positive and at least one negative electrode that are separated from one another by a separator. In electrochemical energy storage cells, an electrochemical, energy-supplying reaction takes place, which is composed of two electrically coupled but spatially separated partial reactions. One partial reaction takes place at a comparatively low redox potential at the negative electrode. The other partial reaction takes place at a comparatively higher redox potential at the positive electrode. During discharge, electrons are released at the negative electrode by an oxidation process, resulting in a flow of electrons via an external consumer to the positive electrode, from which a corresponding quantity of electrons is absorbed. A reduction process therefore takes place at the positive electrode. At the same time, an ion current corresponding to the electrode reaction occurs within the electrochemical energy storage cell for the purpose of charge equalization. This ion current passes through the separator and is made possible by an ion-conducting electrolyte.

In secondary (rechargeable) electrochemical energy storage cells, the discharge reaction is reversible, i.e. it is possible to reverse the conversion of chemical energy into electrical energy during discharge.

An electrochemical energy storage cell often used in battery modules is a lithium-ion cell. It comprises electrodes that can reversibly absorb and release lithium ions, as well as an electrolyte containing lithium ions.

Battery modules often have a cubic housing with a rectangular top and a rectangular base and four rectangular side walls. When assembling the battery modules into a battery or a battery storage system, it is usually intended that the battery modules are aligned next to each other or in stacked form so that they can then be interconnected accordingly.

Heat is generated during the operation of electrochemical cells and in particular during the operation of a battery module. The cells heat up both during energy output and during charging. Overheating can lead to impairment and damage to the electrochemical cells. However, too low a temperature can also have a negative impact on the charging process, for example. For safe and gentle operation of the battery module, a certain operating temperature range should therefore be maintained so that measures for temperature control of battery modules and especially for cooling are useful.

It is known to use cooling and refrigeration circuits to cool the electrochemical cells of a battery module that heat up during operation. For example, cooling or refrigeration plates can be used, onto which the battery modules are pressed with their underside for heat dissipation.

Other approaches work by introducing a liquid cooling medium directly into the battery module. DE 102007024869 A, for example, describes a battery module for electrical appliances in which a cooling medium is fed through the housing of the module.

Air cooling of battery modules is also known. For example, WO 2013/023847 A1 describes a battery module, in particular for motor vehicles, with a battery cell stack of preferably prismatic battery cells, with air ducts located between the battery cells. This is intended to enable sufficient cooling of the battery cells by an air flow.

DE 102014201165 A1 proposes a battery module comprising a number of electrically interconnected battery cells. The individual battery cells are tempered by an air flow that passes through channels that extend essentially along the battery cells. The battery cells are housed in individual battery cell compartments of a battery cell holder. The channels through which the cooling air flows are located in the side walls of the battery cell compartments. To ensure a sufficient cooling effect, the material of the battery cell holder must have good thermal conductivity properties.

DE 202018005411 U1 describes a battery module with cylindrical round cells without a conventional housing, whereby the housing functions are performed by a self-supporting holding matrix made of plastic. Individual modules can be plugged together to form so-called battery packs. In this example, the surface distance between two levels of the assembled modules can be used as an air duct for air cooling.

In addition to good cooling of the energy storage cells in the battery modules of a battery storage system consisting of several battery modules, there is also a general requirement that the energy storage system should be hermetically sealed, depending on the intended IP protection class (IP-International Protection). Furthermore, electrical insulation resistance should be guaranteed. With regard to electromagnetic compatibility, the parasitic capacitances between the energy storage cells and the housing should be as small as possible.

These aspects can be particularly important to meet the requirements of various IP protection classes for such systems, whereby these protection classes define certain safety measures and specifications for certain devices and equipment.

In this respect, conventional air cooling in energy storage systems, in which the air is drawn in from the environment by an integrated fan, passed through the battery module(s) and then heated and released again, may not be suitable due to the requirement for water and dust tightness.

Other solutions to cool the cells, which use thermally conductive materials and structures to transport the heat loss from the energy storage cells to the housing surface, are generally complex and cost-intensive to implement. Furthermore, when using thermally conductive materials, it is generally advisable for the distances between the energy storage cells and the cooling housing wall to be as small as possible. However, this contradicts the requirement for high insulation strength and low parasitic capacities.

Liquid cooling is associated with other difficulties, as conventional water-based coolants are generally electrically conductive and are therefore associated with insulation problems. In this respect, dissipating heat from parts under high voltages by liquid cooling generally represents a major challenge that is associated with complex technical measures.

Another important point is the pressure that may occur in the system, for example, if individual energy storage cells are overcharged or a short circuit occurs. The resulting combustible gases (flue gases) should be kept under control for the purposes of safety and fire protection.

Large-format battery modules (approx. 100 Wh to kWh) pose a particular challenge in terms of fire prevention. In principle, defective energy storage cells pose the problem of becoming so thermally conspicuous that hot gases can escape from them and ignite. With energy storage cells, it must therefore be ensured that no fire can escape from the system and that a possible fire within a battery module cannot spread to adjacent battery modules.

Conventional energy storage systems generally do not offer satisfactory solutions, particularly with regard to these aspects. It could therefore be helpful to provide an improved energy storage system which satisfies the aforementioned requirements for a powerful and safe energy storage system while at the same time being relatively simple in design.

### SUMMARY

We provide a battery storage system which is made up of at least two battery modules, with the individual battery modules each having a plurality of electrochemical energy storage cells. In addition, the battery storage system can optionally have a top part and/or a base part, as is known from conventional battery storage systems. The battery storage system comprises a. to c:
a. each battery module has at least one external contacting device to connect to another battery module of the battery storage system and/or, if applicable, to the base part and/or the top part of the battery storage system,
b. the contacting devices comprise at least one, and in some instances several, connections for power and/or data signals, and
c. adjacent battery modules within the battery storage system are electrically connected to each other via the contacting devices,

Furthermore, the energy storage system is characterized by d. and e:
d. the contacting devices are each surrounded by a circumferential mechanical guide, and
e. at least one gas passage opening is provided in the area of the contacting devices within the circumferential mechanical guide.

As with a conventional battery storage system, the individual battery modules of the system can, for example, be stacked and/or lined up. The contacting devices of the individual battery modules are designed in such a way that the adjacent battery modules can be interconnected. Known connections for power and/or for data signals are provided, in most instances for both power and for data signals.

In a stacked system in particular, a base part and a top part can be provided. The connections of the stack can be made accessible on the upper top part, for example, while the base part only contains the connection technology, for example. In principle, however, the location of the connections for power and data signals can be freely selected depending on the circumstances and requirements and is also possible in the base part, for example. Corresponding lateral parts can be provided for lined up systems.

A key point is that the contacting devices are each surrounded by a circumferential mechanical guide and that at least one gas passage opening is provided within the circumferential mechanical guide. In general, a gas passage opening is to be understood as an opening or an aperture in the wall of the battery module in the area of the contacting device, which allows gas to pass through.

The gas passages provide a path to cool air through the entire energy storage system across the various battery modules. At the same time, or alternatively if necessary, the path provided by the gas passage openings can also be used in a very advantageous manner for the distribution and discharge of any flue gases that may occur. Our system uses the contacting devices, which are generally present anyway and are provided to connect the individual battery modules, for the integration of gas passage openings between the individual battery modules.

The gas passage openings are openings in the housing wall of the respective battery module in the area surrounded by the circumferential mechanical guide of the contacting device. The gas passage openings can have a round or circular shape, for example. In other examples, they can in principle have any other shape, for example, slits or the like. In preferred examples, the gas passage openings can also be formed by a grid structure.

Since the gas passage openings are located within the circumferential mechanical guides of the contacting devices, the connection of the adjacent battery modules via the contacting devices simultaneously enables the passage of gas between the adjacent battery modules. The battery storage system thus allows cooling air or another cooling medium and/or possibly flue gases to pass through in a very advantageous manner without the need for additional, complex measures during assembly. On the one hand, our system thus facilitates the cooling of such battery storage systems and, on the other hand, enables effective flue gas management to prevent battery fires that may occur or to limit their effects.

In a particularly preferred manner, the contacting devices of the battery modules are plug connectors. In terms of their basic design, such connectors are known for contacting adjacent battery modules in a battery storage system as connecting elements for power and/or data signals.

Advantageously, the respective contacting devices, which are provided to plug into each other, are designed to complement each other. For example, the plug-in elements of the contacting device on one side of a first battery module are female and the plug-in elements of the contacting device on the side of an adjacent second battery module that is to be connected to the first battery module are male.

To protect the plug-in connections or plug-in elements in particular, the contacting devices have a circumferential mechanical guide that is stable and protects the connections from mechanical damage, ingress of dust or water or similar.

In a particularly preferred manner, the battery storage system is characterized by the following additional feature:
a. the mechanical guides of the contacting devices, via which adjacent battery modules are connected to each other, interlock positively.

The positive engagement of the mechanical guides of adjacent battery modules makes it particularly easy to plug the battery modules together. The corresponding design of the mechanical guides also prevents mismatched contacting devices from being connected to each other. They can therefore only be pushed into each other if the matching connectors are located opposite each other, for example, a contacting device on the back of a module and a contacting device on the front of an adjacent module. For this purpose, one of the two mechanical guides is conveniently designed to be smaller than its counterpart so that it is mechanically very easy to slide one into the other. Such a design of the mechanical guides thus also fulfills the function of protection against incorrect insertion.

In some arrangements, the battery storage system is further characterized by a.:
a. the mechanical guides are designed to seal the contacting devices.

The sealing of the contacting devices ensures, for example, a seal against gas, moisture and/or dust. The seal also ensures the safe passage of gas so that forced cooling in particular is possible with simultaneous tightness, which can also meet the requirements of various IP protection classes, for example.

Tightness can already be ensured, for example, by the preferred positive connection of the mechanical guides.

In some arrangements, the battery storage system is characterized by at least one of a. and b., especially with regard to sealing:
a. at least a part of the mechanical guides comprises a circumferential sealing lip, and
b. at least a part of the mechanical guides comprises a sealing compound.

A circumferential sealing lip, for example, made of an elastic plastic or rubber, and/or a standard sealing compound in the area of the mechanical guides can achieve a very secure seal.

Depending on the IP protection class to be realized, a hermetic seal may also be required, which can be achieved in particular by a sealing lip or a sealing compound. If hermetic sealing is not required, a form-fit connection may be sufficient for sealing. Depending on the application, protection against the ingress of water may be sufficient, for example.

When the battery modules are stacked to form the battery storage system, the weight of the battery modules alone can be sufficient to achieve such a mechanical pressure for sealing by the positive connection and/or, if necessary, for sealing by rubber lips, sealing compounds or similar, which makes further mechanical fixing, for example, by screws, clamps or retaining springs, superfluous to ensure tightness. On the one hand, this further simplifies assembly, as an additional fixing step is not required. On the other hand, a further source of error during assembly is avoided by dispensing with an additional fixing step.

In some arrangements, the battery storage system is characterized by at least one of a.-c.:
a. each battery module has a housing, in some instances a cuboid housing,
b. a contacting device is arranged on each of at least two opposite sides of the housing, in particular the cuboid housing, and
c. the battery modules are stacked or lined up.

In some instances, the aforementioned features a. and b. or a. and b. and c. are realized in combination.

The design of the battery modules with a housing and in particular with a cuboid housing considerably simplifies the connection and in particular the stacking or lining up of the battery modules to form a battery storage system. In general, cuboid housings for such battery modules are already known in conventional systems so that the cuboid shape can also be used for the system. Thus, battery modules known per se with a cuboid housing can be adapted in the area of the mechanical guides of existing contacting devices such that gas passage openings are provided within the mechanical guides of the contacting devices so that the battery modules are set up for gas passage between adjacent battery modules of the system.

It is particularly advantageous if the contacting devices are arranged on two opposite sides of the cuboid housing. In this example, the individual battery modules can be stacked on top of each other in a particularly simple manner, for example.

In other examples, the contacting devices can be provided on different sides of the housing, but not on opposite sides, for example, on sides that converge at a right angle. This arrangement of the contacting devices enables other geometries when connecting the individual battery modules to each other, for example, in a complex block shape or similar.

In some arrangements, the battery storage system is characterized by at least one of additional a. to b.:
a. two or more gas passages are provided within the mechanical guides of the contacting devices, and
b. within the mechanical guides of the contacting devices, a grid structure is provided as a gas passage opening.

Depending on the design of the contacting devices and, for example, depending on the number of individual plug-in elements and their size within the circumferential mechanical guide of the contacting devices, it may be expedient to provide, for example, two gas passage openings per contacting device, which are located diametrically opposite each other in the corner areas of the contacting devices. Nevertheless, it is also possible to provide only one gas passage opening per contacting device or, if necessary, more than two gas passage openings.

If two contacting devices of adjacent battery modules are connected to each other in the system, it may be useful for the respective gas passage openings to be exactly opposite each other to enable an optimum gas flow. It is also possible that the respective gas passage openings are not exactly opposite each other, as a sufficiently good gas flow may also be possible.

Furthermore, a large number of relatively small gas passage openings can be advantageous, for example, in the form of a wire mesh or similar. In particular, a grid structure as a gas passage opening can offer particular advantages with regard to flame extinguishing in the event of a fire.

Furthermore, in preferred examples, the battery storage system is characterized by at least one of additional a. to b.:
a. the mechanical guides of the contacting devices enclose an area of the respective side surface of the housing of up to 70% of the total area of the side surface, and
b. the gas passage openings of a contacting device cover an area of up to 30% of the total area of the respective side of the housing.

The size or the dimensions of the mechanical guides of the contacting devices with respect to the side surface of the housing generally provides an upper limit for the maximum possible areas of the gas passage openings, since the gas passage openings are located within the mechanical guides. The mechanical guides can at least theoretically cover a maximum of the entire cross-section of the respective side of the housing of the battery module and thus provide a maximum area for the gas passage, whereby the area required for the attachment of the individual connecting elements of the contacting device must also be taken into account.

Depending on the requirements, particularly with regard to cooling and flow behavior, our system offers various adaptation options for the gas passage openings. It is particularly preferred, for example, that the gas passage openings of a contacting device comprise an area of at most 30% of the total area of the respective side of the module housing. On the one hand, this provides a sufficient area for the gas to pass through, especially for cooling purposes. On the other hand, a weakening of the stability of the respective side of the housing is kept within acceptable limits by the openings in the housing wall that are required for the gas passage openings.

In further preferred examples, the battery storage system is characterized by at least one of features a. to k.:
a. the battery storage system is set up for cooling with a gaseous medium, in particular with air,
b. the battery storage system is equipped with means for air cooling,
c. the battery storage system has at least one, and in some instances several fans,
d. the battery storage system has at least one active cooling device, for example, a Peltier element and/or an absorber cooler and/or a compressor cooler,
e. the battery storage system has at least one connection for an external cooling air source,
f. the battery modules have internal structures for air routing and/or ducting, with the internal structures for air routing and/or ducting typically being set up for circulating air routing,
g. the battery storage system is set up for a cyclical reversal of the cooling air direction,
h. the battery storage system is equipped with heat-conducting devices,
i. the battery storage system is equipped with a heat exchanger,
j. the battery storage system is equipped with at least one compressor, and
k. the energy storage cells are cylindrical round cells.

One or more of the aforementioned features a. to k. may be realized in combination.

The use of cylindrical round cells for the battery modules is particularly preferred. Various designs are known for electrochemical energy storage cells and, in particular, for lithium-ion cells. In addition to prismatic shapes, button cells and cylindrical round cells are widely used, with both button cells and round cells having a circular base. Cylindrical round cells differ from button cells in that their height is greater than the diameter of the circular base. When using such cylindrical round cells in a battery module, the cylindrical round cells can, for example, be arranged in the form of battery blocks in which the round cells are arranged vertically next to each other in a plane and are held, for example, by a cell holder made of plastic. The use of cylindrical round cells in such battery modules has the particular advantage that the geometry of the round cells inevitably creates cavities between the individual cells, which are very advantageous for cooling and in particular for air cooling.

The measures to cool the energy storage cells within the respective battery module can, in principle, be carried out using known methods. Air cooling of the energy storage cells is particularly preferred, whereby the air can be distributed between the individual battery modules via the gas passage openings. Fans (ventilators) or other active cooling devices known to the person skilled in the art can be used to drive the cooling air. In some instances, further internal structures, for example, steering plates or similar, are provided within the battery modules to enable optimum air routing and/or conduction.

As an alternative to a fan or ventilator, a compressor can also be used to transport air, which can operate the system at atmospheric overpressure, for example. In this example, the pressurized air absorbs more heat. The system is pressurized, which counteracts the ingress of moisture and/or dust. An expansion of the compressed air can provide further cooling (similar to a refrigeration machine). All in all, a compressor offers various advantages over a fan.

The battery storage system can be provided for coolant routing, in particular cooling air routing, in one direction, for example, from top to bottom or from bottom to top when the battery modules are stacked, or from right to left or from left to right when the battery modules are arranged in a row. However, a circular flow of the coolant and in particular the cooling air can also be provided, whereby delimited chambers within the battery modules facilitate a circulating air flow. In preferred examples, the individual battery modules have one or more partitions which divide the battery modules into two or possibly more separate chambers. With this example, a circumferential coolant routing and, in particular, a circumferential cooling air routing is possible with particular advantage. This can be provided both in an open and in a closed system.

The routing of the air or coolant in general can be an open system, for example, equipped with a fan at the coolant inlet and a ventilation grid at the coolant outlet. In other examples, it can be a closed system that works with a heat exchanger, for example.

In one example of the battery storage system the following additional feature is provided:
a. the battery storage system has at least one humidity and/or flooding sensor.

A humidity and/or flooding sensor enables the system to be switched off in the event of a fault, for example, if water enters the system through a ventilation grid. In this respect, a humidity and/or flooding sensor is very advantageous for safety reasons.

The battery storage system not only offers particular advantages with regard to a defined path for a coolant and in particular to cool air, but also offers particular advantages with regard to fire protection. Hot flue gases, which can arise in the event of a fault, can follow the gas path through the gas passage openings if they cannot escape in any other way. Any flue gases that arise can be directed through the system in a defined manner. They can disperse in the system and cool down in the process.

Alternatively, the battery storage system is further characterized by at least one of additional a. to e.:
a. the battery storage system includes means for cooling and/or discharging flue gases,
b. the battery storage system includes at least one pressure relief valve,
c. the battery storage system comprises at least one pressure relief valve with an integrated metal grid,
d. the battery storage system includes at least one rupture diaphragm as overpressure protection, and
e. the battery storage system comprises at least one cooling material depot.

In some instances, by one or more of the aforementioned features a. to f. a flame can be prevented from escaping from the battery module or the battery storage system in the event of a fault. Furthermore, such measures can prevent hot flue gases within the system from setting other energy storage cells on fire.

In some instances, it is advantageous if the flue gases are not only directed in a defined manner, but also cooled effectively so that they no longer burn when they leave the system.

In this context, a wire mesh with good thermal conductivity is particularly advantageous as a cooling measure, as it can cool a flame in such a way that it virtually “stops” at the wire mesh. A metal grid, for example, in combination with a pressure relief valve, represents a thermal barrier for the flue gases, as the metal grid extracts large amounts of heat from the combustion locally so that combustion stops at this barrier. At the same time, the barrier, i.e. the metal grid, can allow gas to pass through almost unhindered. It is only necessary to ensure that there is sufficient contact surface and heat dissipation and/or heat capacity to stop the combustion process at this point. In the battery storage system, it is therefore provided in preferred examples to place such thermal barriers in the path of any hot combustion gases that may occur so that no flames can escape in the event of a fault, thus increasing the safety of the respective battery module or battery system in a simple and cost-effective manner.

If the gas passage openings themselves are designed as a grid structure, this alone can cause the gases passing through to cool down, especially in escaping flue gases, which offers a particular advantage in terms of the safety of the battery storage system.

A cooling material depot is, in some instances, arranged in a cavity through which any fire gases that occur must flow. The cooling material is a material that is suitable to cool these gases and, if necessary, allowing them to condense. Examples include metal wool or a bulk material such as sand or quartz foam granulate. The cooling material depot, in some instances, contains this material in a gas-permeable bag (e.g. made of Nomex or mineral fiber fabric such as glass). This bag can be fixed in a gas passage opening, for example, by a clamp, bracket, cable tie or an adhesive. A coolant depot can therefore be located in a dedicated chamber, but does not necessarily have to be.

In particular, the interaction of a cooling material depot with pressure relief valves with an integrated metal grid allows considerably larger quantities of flue gas to be cooled and intercepted to a certain extent compared with conventional battery systems, without causing further damage to or by the battery storage system.

The cooling material depots can, for example, be arranged with particular advantage in the area of the gas passage openings, where they provide particularly effective protection against the effects of the outgassing of one or more of the energy storage cells. It is also possible to cool passing flue gases through a large number of small ventilation openings, for example, in the form of a grid structure that forms the gas passage openings, in such a way that an extinguishing effect occurs for any flames that may occur. In this context, for example, slotted structures are also suitable for the gas passage openings. A combination of cooling material depots and ventilation grids or a matrix of many small ventilation openings that form the gas passage openings between the battery modules is particularly suitable in this context.

In a conventional hermetically sealed battery module that does not have any gas exchange devices, a single energy storage cell can build up so much pressure in the housing when it is “blown off” that the battery module may no longer be sealed. As a result, flue gases can escape and, in extreme instances, the battery module can even burst. Thanks to the measures provided, the possibility of gas exchange between adjacent battery modules means that there are many times more space available for the expansion of flue gases so that any pressure build-up that may occur in the system is significantly reduced. The system therefore represents a considerably higher degree of safety with regard to the probability of a battery module bursting and/or with regard to the escape of flue gases.

In addition, the propagation of overheating under the energy storage cells can be prevented by suitable design measures so that only very few cells can become thermally conspicuous within the respective battery module. Propagation can be prevented, for example, by a suitable arrangement of cooling material depots and/or bursting membranes or similar.

The gas passage openings of the battery storage system can in principle also serve exclusively to provide a path for fire gases or smoke gases, independently of a coolant duct. In such a system, for example, a fan or other drives for the cooling air or another coolant can be dispensed with. The gas passage openings alone, which enable gas exchange between the adjacent battery modules, ensure sufficient temperature equalization, which also provides a space for expansion in the event of any fire gases occurring, particularly in the event of a fault, thus preventing hot fire gases from being released to the outside.

With regard to any cooling material depot of the battery storage system, at least one of additional a. to b. is in some instances provided:
a. the cooling material of the cooling material depot is formed by steel wool, in particular coarse steel wool, and/or aluminum wool, in particular coarse aluminum wool, and/or quartz foam granulate and/or an aluminum heat sink and/or an open-pored metal foam and/or rock wool, and
b. the cooling material depot acts as a dust filter.

Coarse steel wool is particularly suitable as a coolant, as the coarse structure prevents the wool from igniting. Coarse aluminum wool is also very suitable and even has better thermal conductivity than steel. Quartz foam granulate (pyrobubbles) is another suitable material for the cooling material depots. Interlocking aluminum heat sinks and/or open-pored metal foams are also suitable. Rock wool is also suitable in this context and should ideally be loosely packed to form only a low flow resistance.

By selecting suitable materials and dimensioning such cooling material depots, the cooling material depot can also act as a dust filter, which may be necessary for environmental reasons and which is also effective as a flue gas cooler. Such a cooling material depot can therefore fulfill two tasks simultaneously.

The flue gases produced during the outgassing of energy storage cells generally consist mainly of high-boiling electrolytes. Due to the sufficient size of the advantageously provided cooling material depot, the flue gases can be cooled so effectively that at least part of the electrolyte vapor condenses again. This leads to a considerable reduction in smoke pollution in the vicinity of the battery storage system concerned in the event of such a fault. In addition, fewer flammable gases are emitted, which also further reduces the risk of fire for the surrounding area. To further optimize this effect, a highly thermally conductive material such as aluminum wool can be combined with absorbent, fire-resistant quartz foam granulate as the material for the coolant depots.

In some examples, the battery storage system is characterized by additional a.:
a. The battery storage system is equipped with at least one access for an extinguishing agent.

The at least one access for the extinguishing agent can be provided on the overall system and/or on one or more of the battery modules. In the event of a fire, this access can be used to fight the fire, in particular by the fire department. Suitable extinguishing agents for such firefighting are known to the skilled person.

In some instances, the battery storage system is characterized by at least one of additional a. to c.:
a. the battery storage system includes at least one means of collecting escaping flue gases,
b. the collecting means is a deployable bag,
c. the bag is made of heat-resistant material, and

The aforementioned features a. and b. may be realized in combination with each other. A combination of features a. to c. is particularly preferred.

In particular in a closed system, such a collection means can be used to absorb a volume requirement that arises especially in the event of flue gas development. The deployable bag can lie folded up in the system and only unfold when a correspondingly high pressure occurs, for example, when energy storage cells are blown off. This measure provides a space for suddenly occurring, volume-demanding flue gas to expand so that the harmful gases are not released into the environment.

In a particularly advantageous way, the bag is made of heat-resistant material so that it is not damaged by the hot flue gases and does not catch fire itself. A suitable material for the heat-resistant bag is, for example, Nomex®, a heat-resistant material developed by Dupont, which is also conventionally used for protective clothing. Polytetrafluoroethylene, for example, can also be used as a material for the bag. A mineral fiber fabric such as glass fiber with or without a coating such as silicone or Teflon is also an option. The material can be gas-tight or have a low permeability so that excess pressure can be blown off if necessary. Balloons made of Teflon film or Kapton are also possible. If less hot gases are to be expected, or if they have already been cooled by a depot as mentioned above, polyester (PET), possibly with a metallic coating, could also be considered.

Alternatively or additionally, cooling of the flue gases before they pass into the collecting means or into the bag can be provided. The aforementioned measures such as a cooling material depot and/or an integrated metal grid, are particularly suitable for this purpose.

Furthermore, a pressure relief valve can be arranged upstream (in the flue gas path) or downstream (housing feed-through) of the collecting means. The collecting means itself, in particular the folded bag, can also provide a certain degree of sealing with overpressure protection due to the folding and friction of the material.

In particularly preferred examples, the collecting means can be arranged on the housing of a battery module or, for example, on a top part or base part of the battery storage system in such a way that the collecting means is pressed out of the housing in the event of filling with flue gases and is blown outwards by the flue gases. When installing the battery storage system in such a configuration, care should be taken to ensure that the passage of the collecting medium through the housing to the outside is not blocked.

Overall, the battery storage system offers the possibility of air cooling or fresh air cooling for systems that have to meet a high IP protection class. Air cooling is considerably cheaper than technically complex liquid cooling. In particular, a heat exchanger is not necessarily required. In addition, the battery storage system offers considerable advantages in terms of fire protection, as a flue gas routing or flue gas management system can be integrated into the system in the manner described in a particularly advantageous way. A further particular advantage of the battery storage system is that cost-effective cooling, in particular the particularly favorable air cooling, is possible both in the open and in the closed system. In principle, both system configurations can be realized with the same battery module. Cooling air routing is also possible in hermetically sealed systems, whereby an improvement in fire protection is achieved at the same time. Finally, the battery storage system allows the individual battery modules to be installed particularly easily. Since the gas passage openings enable direct gas exchange between the individual battery modules, no additional assembly or material is required to guide the cooling air.

Furthermore, our system comprises a battery module which is particularly suitable to build the battery storage system described. The battery module comprises at least one contacting device for connection to another battery module of the battery storage system and/or optionally to a base part and/or a top part of the battery storage system. The at least one contacting device comprises at least one, and in some instances several, connections for power and/or data signals. The battery module is characterized in particular by the fact that the at least one contacting device is surrounded by a circumferential mechanical guide and that at least one gas passage opening is provided in the area of the contacting device within the circumferential mechanical guide. With regard to further advantages and with regard to further preferred features of the battery module, reference is also made to the above description.

In a particularly preferred manner, the battery module is characterized by at least one of additional a. to g.:
a the battery module includes means for cooling and/or discharging flue gases,
b. the battery module includes at least one pressure relief valve,
c. the battery module comprises at least one pressure relief valve with an integrated metal grid,
d. the battery module includes at least one bursting membrane as overpressure protection,
e. the battery module comprises at least one cooling material depot,
f. the battery module is equipped with at least one access for an extinguishing agent, and
g. the battery module includes at least one catcher for escaping flue gases. g

Also with regard to these aforementioned features a. to h. of the battery module, reference is made to the above description, in which various advantages and further features of these aspects are already described.

In addition to the described energy storage system and the described battery module, which are characterized above all by the gas passage openings, our system further comprises a battery storage system or a battery module, in particular a hermetically sealed standalone battery module, which does not have the described gas passage openings, but which has a cooling material depot, in particular in combination with flue gas cooling in the manner described above. The battery storage system or the battery module comprises a plurality of electrochemical energy storage cells and is characterized by at least one cooling material depot. This cooling material depot is used to cool any flue gases that may occur in the battery storage system or the battery module in the manner described above.

The cooling material of the cooling material depot can be formed in particular by steel wool, especially coarse steel wool, and/or by aluminum wool, especially coarse aluminum wool, and/or by quartz foam granulate and/or an aluminum heat sink and/or an open-pored metal foam and/or rock wool. With regard to further features of the cooling material, reference is also made to the above description. In a particularly preferred manner, the cooling material depot can also act as a dust filter.

In principle, the cooling material depot or the multiple cooling material depots can be arranged at various locations in the battery storage system or the battery module. In a particularly preferred manner, the cooling material depot is arranged in the area of a pressure relief valve, for example, in the area of a bursting diaphragm, on an outer housing of the system or the battery module. In this configuration, any flue gases that may develop can first cool down in the area of the cooling material depot before they are released to the outside via the pressure relief valve or the bursting membrane.

Finally, our system comprises a battery storage system or a battery module with a collecting means for any escaping flue gases, irrespective of the gas passage openings described above in the battery modules from which the battery storage system is constructed. The collecting means can be a deployable bag and, in some arrangements, a bag, in some instances a deployable bag, made of heat-resistant material.

One or more collecting means can be provided on the battery module or the battery storage system. The battery module can be part of a battery storage system that comprises several such battery modules with or without collecting means. Please refer to the above description for further features and advantages of the catching means.

Further features and advantages are shown in the following description of examples in conjunction with the drawings. The individual features can be realized individually or in combination with each other.

### BRIEF DESCRIPTION OF THE DRAWINGS

FIG. 1 shows a structure of a battery storage system with a base part and a top part;

FIGS. 2A and 2B show a front side (FIG. 2A) of a battery module and rear side (FIG. 2B) of a battery module, each with a contacting device;

FIG. 3 shows a battery storage system with a vertical air duct in an open system;

FIG. 4 shows a separate battery module with closed chambers to realize a circumferential air flow;

FIG. 5 shows a battery storage system with a circulating air duct in an open system;

FIG. 6 shows a battery storage system with a forward and return flow of coolant in a closed system;

FIG. 7 shows a battery storage system with a circulating air duct in a closed system and flue gas management;

FIG. 8 shows a separate battery module with integrated cooling material depots;

FIG. 9 shows a standalone battery module with cooling material depot; and

FIGS. 10A and 10B show a battery storage system with collecting means for collecting flue gases (normal operation-partial FIG. 10A, fault case-partial FIG. 10B).

### DETAILED DESCRIPTION

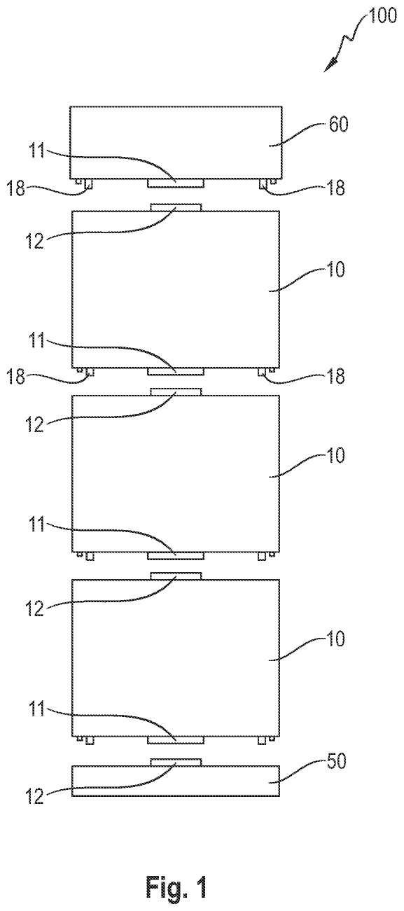

FIG. 1 shows the basic structure of a battery storage system 100, which is formed by three stacked battery modules 10 and a base part 50 and a top part 60. In this illustration, the battery modules 10 are shown in a not yet assembled state. As an alternative to the stacking of the battery modules 10 indicated here, it is also possible, for example, to arrange the battery modules side by side.

The three battery modules 10 shown here as examples are each equipped with a contacting device 11 or 12 on the opposite sides of their cuboid housings. The base part 50 also has a contacting device 12 and the top part 60 has a contacting device 11. The contacting devices 11, 12 are designed as plug connectors.

The contacting devices 11, 12 are each surrounded by a circumferential mechanical guide that protects the contacts or plug-in elements provided inside the contacting devices, which are not shown in detail here. In addition, the contacting devices 11 and 12 are each designed in such a way that they can be plugged into one another. In this design example, the contacting devices 12 or their circumferential mechanical guides are slightly smaller than the contacting devices 11 for this purpose.

The connections for this battery module stack are usually made accessible on the upper top part 60, while the base part 50 only contains connection technology. In principle, however, the location of the connections for power and data signals can be freely selected and is also possible in the base part 50, for example.

Spacers and/or mechanical connecting elements 18 are provided on the lower side of the battery modules 10 and the top part 60 to facilitate stacking and assembly of the battery modules 10.

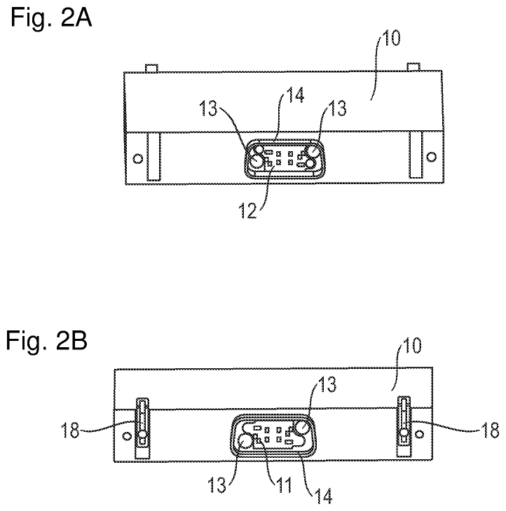

FIGS. 2A and 2B show further details of the contacting devices 11, 12 of the battery modules 10. The contacting devices 11, 12 are each provided with air passage openings 13. The air passage openings 13 are formed by perforations in the housing wall of the respective battery module 10. The gas passage openings 13 are located within the circumferential mechanical guide 14 of the respective contacting device 11, 12. In addition, the connections (plug-in elements) for power and/or data signals, which are known per se and via which the individual battery modules 10 are interconnected, are located within the circumferential mechanical guide 14. FIG. 2A shows the front or upper side of a battery module 10 and FIG. 2B shows the rear or underside of a battery module 10.

The contacting devices 12 and 11 are designed in such a way that they are designed as complementary connectors. For example, the contacting device 12 on the front or upper side is female and the contacting device 11 on the rear or underside of the battery module is male or vice versa.

The circumferential mechanical guide 14 is stable and primarily serves to protect against mechanical damage to the contacting devices or the plug-in elements themselves. The guides 14 are dimensioned so that they can be pushed into each other when the matching contacting devices 12 and 11 are connected to each other. In addition to providing mechanical protection, the guides 14 also ensure that incorrect insertion is avoided. In some instances, the mechanical guides 14 are provided with a seal, for example, a rubber sealing lip or the like, to ensure impermeability to gas, moisture, dust, etc.

In this example, the gas passage openings 13 are circular and are located at two opposite corners of the respective contacting device 11, 12. When the contacting devices 11 and 12 are joined together, the gas passage openings 13 of the two contacting devices 11 and 12 are not directly above each other, but this can still ensure a sufficient gas flow. In other examples, it may be provided that the gas passage openings lie directly opposite each other after the contacting devices have been joined together, whereby the flow resistance can be reduced if necessary.

The gas passage openings 13 enable direct gas exchange and, in particular, the routing of cooling air between the individual battery modules 10 without the need for further measures to route the cooling air between the battery modules such as hoses or similar. In addition, the gas passage openings 13 can be used for flue gas management.

To reduce the flow resistance for the cooling medium passing through, for example, the cooling air, in other examples the circumferential mechanical guides 14 and the gas passage openings 13 enclosed by them can be extended and enlarged compared to this example. The mechanical guides 14 can comprise a maximum of the entire cross-section of the respective side of the battery module 10 so that sufficient surface area or cross-section can be provided for the coolant to pass through. A large number of openings can also be provided, possibly in different shapes, depending on the flow and possibly cooling and fire protection behavior.

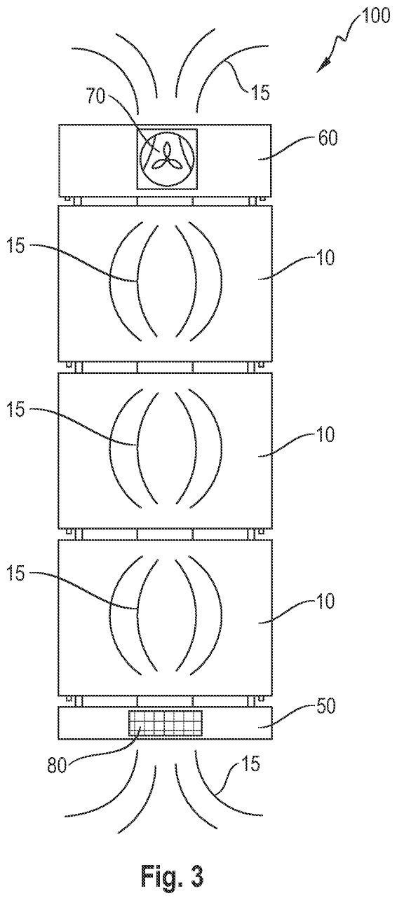

FIG. 3 illustrates an example of a battery storage system, in which a vertical cooling air duct with an air flow either upwards or downwards through the stack of battery modules 10 is realized. The air flows are designated by the reference sign 15. In this example, a fan 70 is provided in the top part 60 and a ventilation grid 80 is provided in the base part 50. The air flow direction can be reversed at times during operation to equalize the thermal load on the energy storage cells within the battery modules 10 on average over time.

In other examples, the fan or fans can also be provided in the lower area of the system, in particular in the base part, or within the stack in one or more battery modules or even outside the system. In addition, connections for an external cooling air source such as a fresh air supply from the environment, or a connection to an air conditioning system or refrigeration machine are possible.

As an alternative or in addition to a fan, active cooling devices can also be provided such as Peltier, absorber or compressor coolers. Furthermore, internal structures can be provided within each battery module for air routing or air ducting or generally for coolant routing or ducting.

By using a moisture and/or flooding sensor, the system can be switched off in the event of a fault, for example, if water enters through the lower ventilation grid 80.

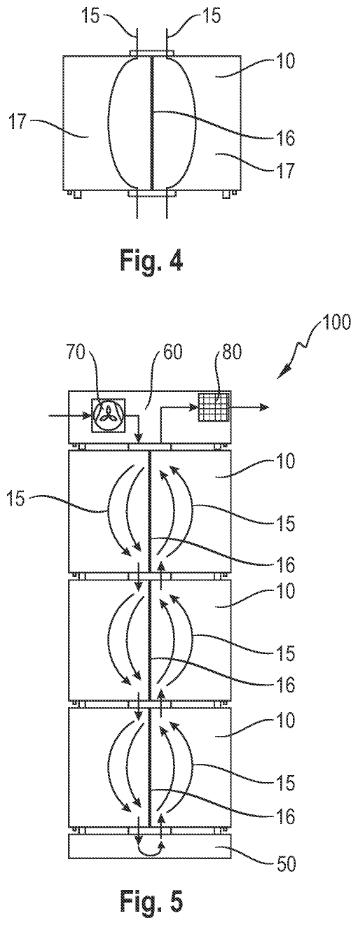

FIG. 4 illustrates a single battery module 10, which is characterized by a subdivision 16 inside the battery module so that in this example two compartments or separate chambers 17 are formed inside the battery module. The chambers 17 allow air to circulate, as illustrated by the battery storage system 100 in FIG. 5. The reference signs 15 again indicate the direction of air flow. In this example, the air inlet and the air outlet are provided in the top part 60 of the battery storage system, but can also be realized elsewhere, for example, in the base part 50, or elsewhere within the stack of battery modules 10. The air flow is driven by a fan or ventilator 70 in the top part 60 and is discharged from the battery storage system via a ventilation grid 80, also in the top part 60, after passing through the battery modules 10 and the base part 50.

To avoid a high temperature gradient along the air path, the air speed can be set correspondingly high. In addition or instead, the flow direction can also be reversed cyclically to equalize the thermal load on the batteries.

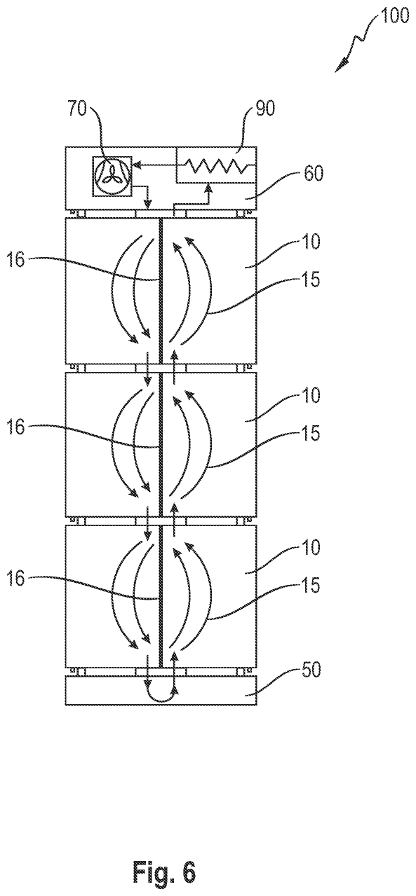

FIG. 6 illustrates a further battery storage system 100 with several stacked battery modules 10 as well as a base part 50 and a top part 60. Comparable to the configuration of the battery system in FIG. 5, partitions 16 are also provided here to divide the battery modules 10 into separate chambers. This enables a circulating air flow in this closed system, whereby a particularly good cooling is possible due to a back and forth flow of the coolant within the battery modules. Due to the gas passage openings provided which enable an exchange of air or coolant between the individual battery modules 10 and the top part 60 and the base part 50, no further channels, pipes or hoses are required to close the coolant circuit. The direction of ventilation can be changed cyclically to equalize the temperature distribution.

Furthermore, in this explained, each battery module 10 can include one or more thermally conductive measures/components that thermally couple the separate chambers, for example, a thermally conductive base plate or a housing wall that acts as a heat exchanger.

In this configuration, in addition to the fan or ventilator 70, a dedicated heat exchanger 90 is provided in the top part 60, which serves to cool the circulated cooling air. In principle, however, the system can also operate without such a heat exchanger. If the surface of the battery storage system 100 is to serve as a heat sink, this closed system can help cool hotspots and dissipate heat. In this example, the outer surface of the system serves as a heat sink that can passively dissipate the heat of the air circulated inside to the environment. When the air inside the system is actively circulated, the constant air movement ensures that areas with particularly high heat output per surface (hot spots) are cooled and the temperatures are equalized to a certain extent.

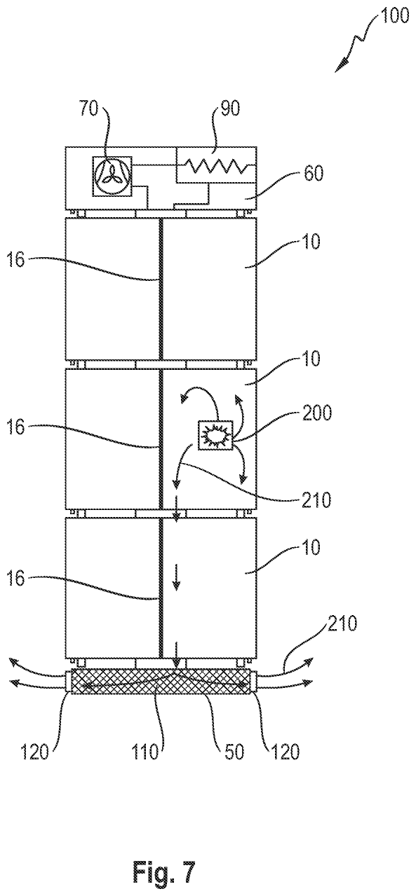

FIG. 7 shows a battery storage system 100, whereby in this example, in contrast to the system shown in FIG. 6, a cooling material depot 110 is provided in the base part 50. In addition, two pressure relief valves or bursting diaphragms 120 are provided in the area of the base part 50. If, in this example, the energy storage cell 200, which is located in the central battery module 10, were to become thermally conspicuous and outgas and possibly even catch fire, the resulting flue gases 210 would follow the path that offers the least resistance. The path of the flue gases 210 is indicated here by arrows. The volume-demanding flue gases 210 can be distributed over several battery modules 10, which counteracts a dangerous increase in pressure. In the event that the increase in pressure can no longer be absorbed despite the increased volume, the cooling material depot 110 in the base part 50, in combination with the pressure relief valves or bursting membranes 120, ensures that the excess pressure can be reduced in a controlled manner. The intended cooling of the flue gases 210 considerably reduces the risk of fire.

The pressure relief valves or bursting membranes 120 are advantageously positioned in such a way that any escaping flue gases 210 are directed to less critical areas such as the floor, wall or similar. It is also possible to direct flue gases through a pipe or hose to the outside. What is particularly advantageous here is that, in principle, a single bursting membrane, which is relatively expensive, can be sufficient for the entire system. In particular, it is generally not necessary for each individual battery module 10 to be equipped with a bursting membrane or other overpressure protection.

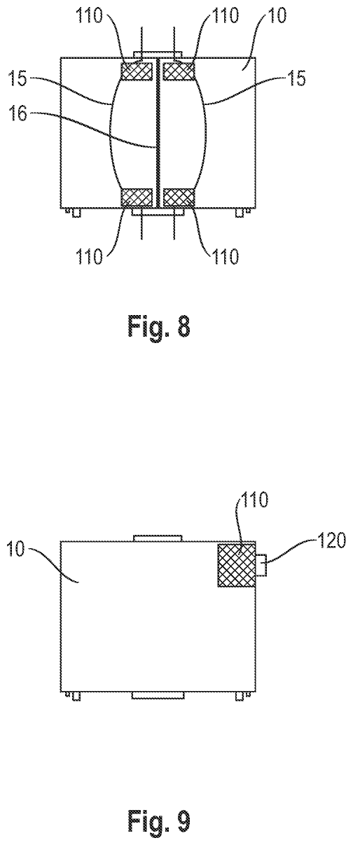

FIG. 8 shows an example of a battery module 10 in which several cooling material depots 110 are provided within the battery module 10, which are arranged in the area of the gas passage openings 13 (not shown here in more detail). This measure can also provide very effective protection against the effects of the outgassing of one or a few energy storage cells within the battery module 10. Furthermore, it is possible that smoke gases passing through a large number of small ventilation openings, which form the gas passage openings, are already cooled to such an extent that an extinguishing effect occurs for any flames that may occur. In this example, the gas passage openings can also be advantageously realized as slits. Combined measures with cooling material depots and ventilation grids or with a matrix of many small ventilation openings are particularly advantageous.

FIG. 9 shows a hermetically sealed standalone battery module 10, which realizes very effective fire protection solely through the cooling material depot 110 provided, which is located in the area of a pressure relief valve or a bursting membrane 120. Such flue gas cooling in a standalone module is also covered.

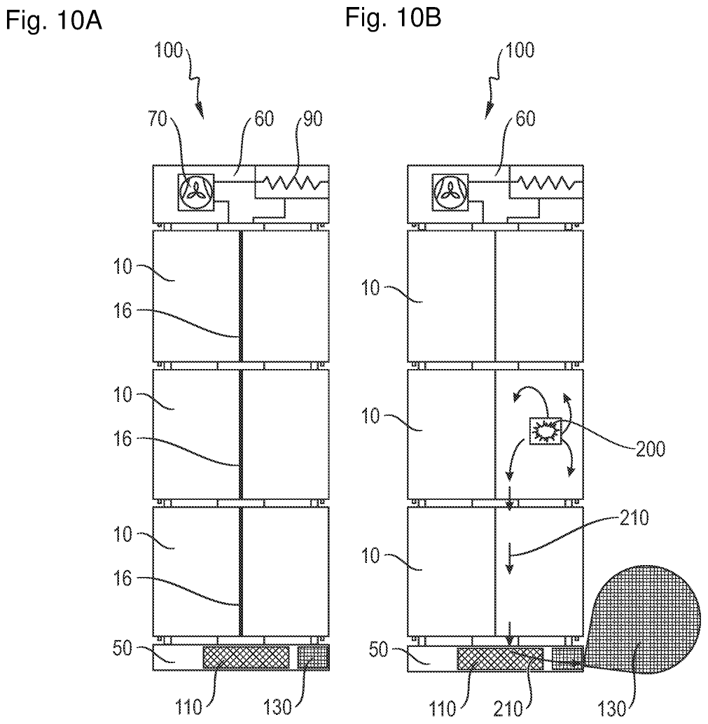

FIGS. 10A and 10B show another particularly advantageous design of the battery storage system 100, which implements a circulating cooling air flow in a closed system in a similar way to the previously explained examples. In addition, as a further fire protection measure, a collecting means 130 in the form of a foldable bag is provided here, which is arranged in the base part 50 of the system. Partial FIG. 10A shows normal operation. Partial FIG. 10B shows the fault case in which flue gas 210 is generated by the thermally conspicuous energy storage cell 200.

The foldable bag 130 is normally in the folded state in the system and only unfolds when a correspondingly high pressure occurs, in particular due to the blowing off of one or more energy storage cells within the battery modules 10 of the system. The path of the flue gases 210 is shown by arrows.

It is particularly advantageous if the flue gases 210 are cooled via the cooling material depot 110 provided here in the base part 50 of the battery storage system 100 before entering the foldable bag 130. If necessary, cooling or the cooling material depot 110 can also be dispensed with. In this example, it is very useful if the foldable bag 130 is made of a heat-resistant material so that it cannot catch fire itself.

If flue gases 210 actually occur in the event of a fault and enter the bag or the collecting means 130, the bag 130 is pressed out of the housing or, in this instance, out of the base part 50 of the battery storage system 100 and inflated by the flue gases 210.

1.-15. (canceled)

16. A battery storage system comprising:
at least two battery modules, each having a plurality of electrochemical energy storage cells, and optionally a base part and/or a top part, wherein
a. each battery module has at least one external contacting device for connection to another battery module of the battery storage system and/or, if applicable, to the base part and/or the top part of the battery storage system,
b. the contacting devices comprise at least one connections for power and/or data signals,
c. adjacent battery modules within the battery storage system are electrically connected to each other via the contacting devices,
d. the contacting devices are each surrounded by a circumferential mechanical guide, and
e. at least one gas passage opening is provided in the area of the contacting devices within the circumferential mechanical guide.

17. The battery storage system according to claim 16, wherein:
a. the contacting devices are plug connectors.

18. The battery storage system according to claim 16, wherein:
a. the mechanical guides of the contacting devices, via which the adjacent battery modules are connected to each other, interlock positively.

19. The battery storage system according to claim 16, having the following additional feature:
a. the mechanical guides are designed to seal the contacting devices.

20. The battery storage system according to claim 16, having at least one of the following additional features:
a. at least a part of the mechanical guides comprises a circumferential sealing lip, and
b. at least a part of the mechanical guides comprises a sealing compound.

21. The battery storage system according to claim 16, having at least one of the following additional features:
a. each battery module has a housing, preferably a cuboid housing,
b. a contacting device is arranged on each of at least two opposite sides of the housing, in particular the cuboid housing, and
c. the battery modules are stacked or lined up.

22. The battery storage system according to claim 16, having at least one of the following additional features:
a. two or more gas passage openings are provided within the mechanical guides of the contacting devices, and
b. within the mechanical guides of the contacting devices, a grid structure is provided as a gas passage opening.

23. The battery storage system according to claim 16, having at least one of the following additional features:
a. the mechanical guides of the contacting devices enclose an area of the respective side surface of the housing of up to 70% of the total area of the side surface, and
b. the gas passage openings of a contacting device comprise an area of up to 30% of the total area of the respective side of the housing.

24. A battery storage system according to claim 16, having the following additional feature:
a. the battery storage system has at least one humidity and/or flooding sensor.

25. Battery storage system according to claim 16, having at least one of the following additional features:
a. the battery storage system comprises means for cooling and/or discharging flue gases,
b. the battery storage system comprises at least one pressure relief valve,
c. the battery storage system comprises at least one pressure relief valve with an integrated metal grid,
d. the battery storage system comprises at least one rupture diaphragm as overpressure protection, and
e. the battery storage system comprises at least one cooling material depot.

26. The battery storage system according to claim 25, having at least one of the following additional features:
a. the cooling material of the cooling material depot is formed by steel wool and/or aluminum wool and/or quartz foam granulate and/or an aluminum heat sink and/or an open-pored metal foam and/or rock wool, and
b. the cooling material depot acts as a dust filter.

27. A battery storage system according to claim 16, having the following additional feature:
a. the battery storage system is equipped with at least one access for an extinguishing agent.

28. A battery storage system according to claim 16, having the following additional feature:
a. the battery storage system comprises at least one collecting means for escaping flue gases, the collecting means preferably being a deployable bag, in particular a bag made of heat-resistant material.

29. A battery module having at least one contacting device for connection to another battery module of a battery storage system and/or optionally to a base part or a top part of a battery storage system, the at least one contacting device comprising at least one, preferably a plurality of connections for power and/or data signals, characterized by the following additional features:
a. the at least one contacting device is surrounded by a circumferential mechanical guide.
b. in the area of the contacting device, at least one gas passage opening is provided within the circumferential mechanical guide.

30. The battery module according to claim 29, wherein the battery module has at least one of the following features:
a. the contacting devices are plug connectors.
b. the mechanical guides of the contacting devices, via which the adjacent battery modules are connected to each other, interlock positively,
c. the mechanical guides are designed to seal the contacting devices,
d. at least a part of the mechanical guides comprises a circumferential sealing lip,
e. at least a part of the mechanical guides comprises a sealing compound,
f. each battery module has a housing, preferably a cuboid housing,
g. a contacting device is arranged on each of at least two opposite sides of the housing, in particular the cuboid housing,
h. the battery modules are stacked or lined up,
i. two or more gas passage openings are provided within the mechanical guides of the contacting devices,
j. within the mechanical guides of the contacting devices, a grid structure is provided as a gas passage opening,
k. the mechanical guides of the contacting devices enclose an area of the respective side surface of the housing of up to 70% of the total area of the side surface, and
l. the gas passage openings of a contacting device comprise an area of up to 30% of the total area of the respective side of the housing.

31. Battery module according to claim 30 with the following additional feature:
a. The battery module comprises means for cooling and/or discharging flue gases and/or at least one collecting means for escaping flue gases.
